(19) United States
(12) Patent Application Publication
(10) Pub. No.: US 2026/0343288 A1
(43) Pub. Date: Oct. 29, 2026

(54) CONDITIONAL MEASUREMENT REPORTING

(71) Applicant: Nokia Technologies Oy, Espoo (FI)

(72) Inventors: Diomidis MICHALOPOULOS, Munich (DE); Tao Tao, Shanghai (CN); Mikko SÄILY, Espoo (FI); Jan Torst HVIID, Aalborg (DK); Knud KNUDSEN, Aalborg (DK); Yong LIU, Shanghai (CN); Yan MENG, Shanghai (CN)

(21) Appl. No.: 19/115,212

(22) PCT Filed: Sep. 28, 2022
(86) PCT No.: PCT/CN2022/122319

§ 371 Date: Mar. 25, 2025

(51) Int. Cl. H04W 24/10

(52) U.S. Cl. CPC H04W 24/10

(57) ABSTRACT

Embodiments of the present disclosure relate to conditional measurement reporting. A terminal device receives, from a network device, a first message comprising one or more conditions indicative of relative levels of one or more measurements performed by the terminal device. Based on determining that at least one of the one or more conditions of the relative levels is met, the terminal device reports the one or more measurements through transmitting a second message to the network device. In this way, unnecessary signaling and power consumption at the terminal device side may be avoided, thereby saving energy.

### FIELD

Various example embodiments relate to the field of telecommunication and in particular, to methods, devices, apparatuses and a computer readable storage medium for conditional measurement reporting.

### BACKGROUND

With the development of communication systems, new technologies have been proposed. Reduced capabilities (RedCap) positioning is an agenda item within the Release 18 (Rel-18) study items (SI) on enhanced positioning. RedCap positioning involves positioning of terminal devices (UE) with reduced capabilities where the main driving factor is the low energy consumed at the terminal device as well as the terminal device's cost.

In many cases, RedCap positioning involves finding the coordinates of terminal devices with low mobility in relatively low accuracy (that is, they may occasionally move from one area to another) with relatively low accuracy (that is, the rough location of the device is needed at an “area”-level (e.g., which area within the warehouse or factory hall) or at a “room”-level (e.g., which room within the building). In such cases, RedCap devices would not need to report their location for a large period of time as this remains the same (again at an area-level or room-level). However, Third Generation Partnership Project (3GPP) standards involve periodic measurement reporting (for UE-assisted positioning) or location reporting (for UE-based positioning) from device to network, there is no known mechanism in the standards that allow RedCap devices to indicate to the network that a “noteworthy” change in their location has occurred, which corresponds to a change on the area or room that is located. It still needs to further improve the solution of conditional measurement reporting.

### SUMMARY

In general, example embodiments of the present disclosure provide a solution for conditional measurement reporting.

The solution may suggest that RedCap devices (generally, may apply to a terminal device or a UE) would not need to report their location for a large period of time as this remains the same (again at an area- or room-level), such that RedCap devices may save energy. Once the RedCap device moves to a new location and stays there for a decent period of time the network should be updated with the new whereabouts of the RedCap device. Still, no frequent updates are needed from the RedCap device's side, unless the RedCap device moves again to a new location.

In a first aspect, there is provided a terminal device. The terminal device includes at least one processor and at least one memory storing instructions. The instructions are configured to, when executed by the at least one processor, cause the first terminal device to receive, from a network device, a first message may include one or more conditions indicative of relative levels of one or more measurements performed by the terminal device; and report, to the network device, the one or more measurements through transmitting a second message, based on determining that at least one of the one or more conditions of the relative levels is met.

In a second aspect, there is provided a network device. The network device includes at least one processor and at least one memory storing instructions. The instructions are configured to, when executed by the at least one processor, cause the network device to transmit, to a terminal device, a first message may include one or more conditions indicative of relative levels of one or more measurements performed by the terminal device; and receive, from the terminal device, the one or more measurements through a second message transmitted based on having met at least one of the one or more conditions of the relative levels of the one or more measurements performed by the terminal device.

In a third aspect, there is provided a method. The method includes receiving, at a terminal device from a network device, a first message may include one or more conditions indicative of relative levels of one or more measurements performed by the terminal device; and reporting, to the network device, the one or more measurements through transmitting a second message, based on determining that at least one of the one or more conditions of the relative levels is met.

In a fourth aspect, there is provided a method. The method includes transmitting, at a network device to a terminal device, a first message may include one or more conditions indicative of relative levels of one or more measurements performed by the terminal device; and receiving, from the terminal device, the one or more measurements through a second message transmitted based on having met at least one of the one or more conditions of the relative levels of the one or more measurements performed by the terminal device.

In a fifth aspect, there is provided an apparatus may include means for receiving, at a terminal device from a network device, a first message may include one or more conditions indicative of relative levels of one or more measurements performed by the terminal device; and means for reporting, to the network device, the one or more measurements through transmitting a second message, based on determining that at least one of the one or more conditions of the relative levels is met.

In a sixth aspect, there is provided an apparatus may include means for transmitting, at a network device to a terminal device, a first message may include one or more conditions indicative of relative levels of one or more measurements performed by the terminal device; and means for receiving, from the terminal device, the one or more measurements through a second message transmitted based on having met at least one of the one or more conditions of the relative levels of the one or more measurements performed by the terminal device.

In a seventh aspect, there is provided a non-transitory computer readable medium may include program instructions for causing an apparatus to perform at least the method according to any one of the above third or fourth aspect.

In an eighth aspect, there is provided a computer program may include instructions, which, when executed by an apparatus, cause the apparatus at least to: receive, from a network device, a first message may include one or more conditions indicative of relative levels of one or more measurements performed by the terminal device; and report, to the network device, the one or more measurements through transmitting a second message, based on determining that at least one of the one or more conditions of the relative levels is met.

In a ninth aspect, there is provided a computer program may include instructions, which, when executed by an apparatus, cause the apparatus at least to: transmit, to a terminal device, a first message may include one or more conditions indicative of relative levels of one or more measurements performed by the terminal device; and receive, from the terminal device, the one or more measurements through a second message transmitted based on having met at least one of the one or more conditions of the relative levels of the one or more measurements performed by the terminal device.

In a tenth aspect, there is provided a terminal device. The terminal device includes receiving circuitry configured to receive, from a network device, a first message may include one or more conditions indicative of relative levels of one or more measurements performed by the terminal device; and reporting circuitry configured to report, to the network device, the one or more measurements through transmitting a second message, based on determining that at least one of the one or more conditions of the relative levels is met.

In an eleventh aspect, there is provided a network device. The network device includes transmitting circuitry configured to transmit, to a terminal device, a first message may include one or more conditions indicative of relative levels of one or more measurements performed by the terminal device; and receiving circuitry configured to receive, from the terminal device, the one or more measurements through a second message transmitted based on having met at least one of the one or more conditions of the relative levels of the one or more measurements performed by the terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a signaling chart illustrating an example process according to some embodiments of the present disclosure;

FIG. 3 illustrates an example environment of an optimized conditional measurement reporting in some example embodiments of the present disclosure;

FIG. 4 illustrates an example of an optimized conditional measurement reporting procedure which may be used in example embodiments of the present disclosure;

FIG. 5 illustrates a flowchart of a method implemented at a terminal device according to some embodiments of the present disclosure;

FIG. 6 illustrates a flowchart of a method implemented at a network device according to some embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Non-terrestrial network(NTN) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, the sixth generation (6G) communication protocols and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS), a location management function (LMF), or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, a non-terrestrial network (NTN) or non-ground network device such as a satellite network device, a low earth orbit (LEO) satellite, a medium earth orbit (MEO) satellite and a geosynchronous earth orbit (GEO) satellite, an aircraft network device, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The term “RedCap device” refers to a terminal device with reduced capabilities. In 5G New Radio (NR) Release 17, 3GPP introduced a new tier of reduced capability (RedCap) devices, also known as NR-Light. It is a new device platform that bridges the capability and complexity gap between the extremes in 5G today with an optimized design for mid-tier use cases. When compared to 5G enhanced mobile broadband (eMBB) devices that may support gigabits per second of throughput in the downlink and uplink, RedCap devices may efficiently support 150 Mbps and 50 Mbps in the downlink and uplink, respectively, due to the designed optimizations. The reduced complexity contributes to more cost-efficient RedCap devices, longer battery life due to lower power consumption, and a smaller device footprint, which enables newer designs for a broad range of use cases.

RedCap positioning is an agenda item within the Rel-18 SI on enhanced positioning. RedCap positioning involves positioning of devices with reduced capabilities (RedCap) where the main driving factor is the low energy consumed at the terminal device 120 as well as the device's cost.

In many cases, RedCap positioning involves finding the coordinates of devices with low mobility (that is, they may occasionally move from one area to another) with relatively low accuracy (that is, the rough location of the device is needed at an “area”-level (e.g., which area within the warehouse or factory hall) or at a “room”-level (e.g., which room within the building).

In such cases, RedCap devices would not need to report their location for a large period of time as this remains the same (again at an area-level or room-level), such that they may save energy. Once the device moves to a new location and stays there for a decent period of time the network should be updated with the new whereabouts of the device. Still, no frequent updates are needed from the device's side, unless the device moves again to a new location.

There is no known mechanism in the standards that allow RedCap devices to indicate to the network that a “noteworthy” change in their location has occurred, which corresponds to a change on the area or room that is located. Instead, 3GPP standards involve periodic measurement reporting (for UE-assisted positioning) or location reporting (for UE-based positioning) from device to network. Using such legacy approach would result in unnecessary signalling and power consumption at the device side, since the device would need to report measurements or location irrespective of whether level of location details are needed. Even if the location service (LCS) quality of service (QoS) indicates low accuracy requirement there is no known mechanism to translate such relaxed QoS to a conditional reporting from the device.

There is thus a gap in the standards such that the RedCap device may not be configured to report (measurements or location) only if there is an indication that the device is in a new area or room. Although the above analysis is provided mainly based on the RedCap devices, it is noted that some problems or issues may also exist when normal terminal devices are considered.

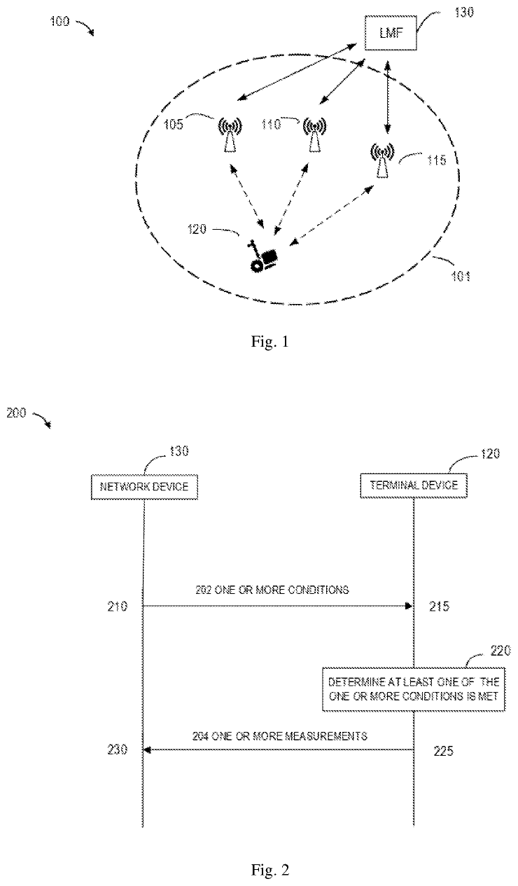

According to embodiments of the present disclosure, there is provided a solution for conditional measurement reporting. In this solution, a terminal device receives, from a network device, a first message may include one or more conditions indicative of relative levels of one or more measurements performed by the terminal device. Moreover, the terminal device reports, to the network device, the one or more measurements through transmitting a second message, based on determining that at least one of the one or more conditions of the relative levels is met. As such, unnecessary signaling and power consumption may be avoided, thereby saving energy. Example embodiments of the present disclosure for determination of the terminal device's identity will be described below with reference to FIGS. 1-8.

FIG. 1 illustrates an example network environment 100 in which example embodiments of the present disclosure may be implemented. The environment 100, which may be a part of a communication network, includes a serving cell 101, a first transmission reception point (TRP) 105, a second TRP 110, a third TRP 115, a terminal device 120 as well as a network device 130. It is to be understood that the number of TRPs shown in the environment 100 only for the purpose of illustration, but without any limitation to the scope of the present disclosure.

The UE 120 (also referred as “a terminal device 120” or “a user equipment 120” in the following) and the network device 130 (also referred as “location management function (LMF)” or “LMF 130” in the following) may communicate data and control information to each other via the TRP 105 (also referred as “a first TRP 105” in the following), the TRP 110 (also referred as “a second TRP 110” in the following) and TRP 115 (also referred as “a third TRP 115” in the following) in the coverage of the serving cell 101. In another embodiment, the network device 130 may be a network node, such as a gNB, including the functions of the LMF integrated therein.

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

Communications in the communication system 100 may be implemented according to any proper communication protocol(s), may include, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, may include but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

FIG. 2 illustrates a signaling chart illustrating an example process according to some embodiments of the present disclosure. For the purpose of discussion, the process 200 will be described with reference to FIG. 1. The process 200 may involve the terminal device 120, the network device 130 as illustrated in FIG. 1. It would be appreciated that although the process 200 for link has been described in the communication system 100 of FIG. 1, this process may be likewise applied to other communication scenarios.

In the process flow 200, the network device 130 may transmit 210 a first message may include one or more conditions 202 to a terminal device 120, such as a RedCap device. The one or more conditions 202 may be indicative of relative levels of one or more measurements performed by the terminal device. On the other side of the communication, the terminal device 120 may receive the first message which may include one or more conditions 202 from the network device 130. The one or more conditions 202 indicative of relative levels of one or more measurements performed by the terminal device 120.

In some embodiments, the one or more conditions 202 may be included as at least one information element within the first message. In an example, the network device 130 (e.g., LMF) may use a new information element (IE) within a LPPRequestLocationInformation message for positioning the terminal device 120 (e.g., a RedCap device). In this new IE, the network device 130 may provide the UE-specific conditions determined to the UE.

In some embodiments, in order to report or to update the one or more location measurements of the terminal device 120 (UE 120 may be used interchangeably with the terminal device 120, or a RedCap UE throughout the description), the receiving of the first message from the network device 130 (LMF 130 may be used interchangeably with the network device 130 having integrated functions of the LMF throughout the description) may be conditioned upon the network device 130 first defining the one or more conditions of the relative levels of one or more measurements that are at least to be partially met by the terminal device 120. In an example, the network device 130 may obtain UE capabilities and identify that the terminal device 120 may be a RedCap UE. In an example, for identified RedCap UEs 120, the network device 130 may determine the conditions on measurement reporting, and the conditions needs to be satisfied by the terminal device in order for the terminal device 120 to report measurements.

In some embodiments, the one or more conditions are terminal device specific which may be based on specifying at least one of: a quality of service (QoS) for a positioning session of the terminal device 120, or expected area information of the terminal device 120. In an example, the conditions may be defined UE-specific, based on the QoS for the positioning session of the terminal device 120 and based on the expected area information of the UE.

In some embodiments, the one or more measurements performed by the terminal device 120 include at least one of: positioning reference signal (PRS) combinations from different transmission reception points (TRP) to be measured by the terminal device 120 for reporting; a harvested energy configuration of the terminal device; time duration between reports in case of periodic positioning by the terminal device, or a maximum number of consecutive reports in case of periodic positioning by the terminal device.

In an example, the new IE contains information on conditional reporting of positioning measurements or location estimate. The content of IE includes: PRS combinations that need to be measured by the terminal device 120 for the terminal device 120 to provide report; harvested energy configuration; time between reports and max number of consecutive reports in case of periodic positioning In some embodiments, the network device 130 may determine the PRS combinations based on an expected area of interest and a topology of transmission reception points (TRP).

After receiving the one or more conditions 202 from the network device 130, the terminal device 120 determines 220 whether at least one of the one or more conditions 202 of the relative levels is met. In an example, the terminal device 120 checks conditions in the new IE and provides measurement reports as part of the LPPProvideLocationInformation message only if the configured conditions are met.

In some embodiments, the terminal device 120 may measure the PRS combinations for the reporting based on determining that a change of reference signal received power (RSRP) exceeds a threshold. The PRS combinations may be specific to location measurements.

In some embodiments, in order to determine the condition indicative of the relative levels of the measurements of the PRS combinations from the different transmission reception points (TRP) performed by the terminal device 120 is met, the terminal device 120 may determine 220 at least one or a combination of: the PRS received powers have changed more than a threshold or defined relative power units (dB); measured time differences of arrival have changed more than a defined time durations (s); or the PRS combinations that exceed configured bounds.

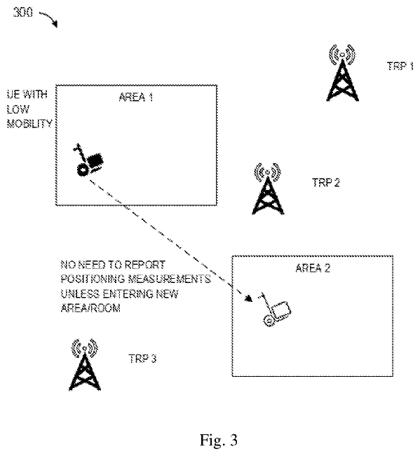

FIG. 3 illustrates an example environment of an optimized conditional measurement reporting in some example embodiments of the present disclosure. For the purpose of discussion, the environment 300 will be described with reference to FIG. 1. As shown in FIG. 3, the terminal device 120 with low mobility may report measurements to the network device 130 when it moves from area 1 to area 2. In an example, the terminal device 120 may not need to report positioning measurements unless entering another new area/room.

For example, PRS combinations (e.g., PRS from TRP #1 is received with RSRP which is at least x dB stronger than any of other detected TRPs) that need to be measured by the terminal device 120 in order to report measurements. The determination of the PRS combinations that lead to a report being sent/not being sent is done at the network device 130 may be based on the expected area of interest (e.g., area 1 in FIG. 3) and the topology of the TRPs. For example, with reference to FIG. 3, if the area of interest (area 1) corresponds to a relative distance to TRP #2 being 2-times closer than any of the remaining two TRPs (TRP #1 and TRP #3), this difference in proximity may correspond to a change by 6 dBs of relevant received RSRP (that is, x=6 dB in this example). In another network topology and/or another area of interest the value x may be adjusted to the new topology and/or area.

The reasoning for this message is to make sure that if the terminal device 120 is still in the same area (room, region, etc.) it does not report measurements. For example, if the terminal device 120 sees the same gNB much stronger than the others for some time that would give an indication that the area has not changed during this time.

In an example, a report follows if more than X number of measured PRS Rx power (by means of reference signal receiving power, RSRP) or more than X number of measured time difference of arrival (by means of reference signal time difference, RSTD) has changed more than Y dB (for RSRP) or more than Y milliseconds (for RSTD). In another example, a report should follow only if such PRS receive (Rx) power combinations or PRS RSTD goes out of the configured bounds. In yet another example, a report should follow only if a specified difference on PRS Rx power or the PRS RSTD is measured.

In some embodiments, in order to determine the condition indicative of the relative levels of the measurements of the harvested energy configuration is met, the terminal device 120 may determine 220 that the harvesting energy is greater than or equal to an energy threshold. In an example, in the case of the terminal device 120 is harvesting energy, energy harvested at device is not less than X joules.

In some embodiments, the terminal device 120 may determine 220 the condition associated with the time duration between reports based on after determining that the condition associated with the PRS combinations is not met in case of periodic positioning of the terminal device, determine a time interval after transmitting a measurement report is equal to the time duration between reports.

In an example, in the case of periodic reporting, the new IE (information element) may include maximum time between reports. This is to ensure that some report is provided after long time even if the device is in the same room, thus to ensure system stability.

In some embodiments, the terminal device 120 may determine 220 the condition associated with the maximum number of consecutive measurement reports based on after determining that the condition associated with the PRS combinations and the harvested energy configuration are met in case of periodic positioning of the terminal device, wherein the terminal device 120 is caused to determine a number of consecutive measurement reports that have been transmitted is less than the maximum number of consecutive measurement reports.

In an example, in the case of periodic reporting, the new IE includes max number of consecutive reports to be provided to network in case conditions associated with PRS combinations and harvested energy are met.

In some embodiments, a reporting periodicity is determined based on a scaling factor associated to a mobility of the terminal device. In an example, the lower the mobility the longer time between the positioning reporting.

Based on determining 220 that at least one of the one or more conditions 202 of the relative levels is met, the terminal device 120 reports 225 the one or more measurements 204 through transmitting a second message to the network device 130. The network device 130 receives the one or more measurements 204 through the second message from the terminal device 120. In some embodiments, the RedCap UE may decide on whether to provide a measurement report to the network device 130 based on any of the conditions configured above.

In some embodiments, based on determining 220 that none of the one or more conditions 202 of the relative levels is met, the terminal device 120 may report through the second message (e.g., LPPProvideLocationInformation message) to the network device 130 without reporting location measurements, which indicates none of the conditions of the relative levels has been met by the terminal device 120. In an example, the terminal device 120 may implicitly indicate that conditions are not met to the network device 130 by sending a null input into the LPPProvideLocationInformation message.

In some embodiments, based on determining 220 that none of the one or more conditions 202 of the relative levels is met, the terminal device 120 may report through the second message with an indication. The indication flagging one or more conditions of the relative levels that have not been met by the terminal device. In an example, the terminal device 120 may flag that conditions are not met by instigating another new IE within the LPPProvideLocationInformation message.

In some embodiments, in response to the receiving 215 of the first message (e.g., LPPRequestLocationInformation message) from the network device 130, the terminal device 120 may transmit the indication flagging one or more conditions of the relative levels that have not been met once. In an example, if conditions are not met, the terminal device 120 may flag this to the network 100 only once, as a response to the IE within the LPPRequestLocationInformation message.

In some embodiments, the first message includes a request to provide positioning-related measurements message, and the second message includes a provision of positioning-related measurements message.

In some embodiments, in order to determine a location of the terminal device 120, the second message includes location measurements or updates of the location measurements.

In some embodiments, the reporting of the location measurements of the terminal device 120 through the second message may be aperiodic. And the reporting of the location measurements take place when one or more conditions 202 of the relative levels are met by the terminal device 120.

In some embodiments, the reporting of the location measurements or a location updated by the terminal device 120 may enable a new positioning determination or a movement detection of the terminal device 120.

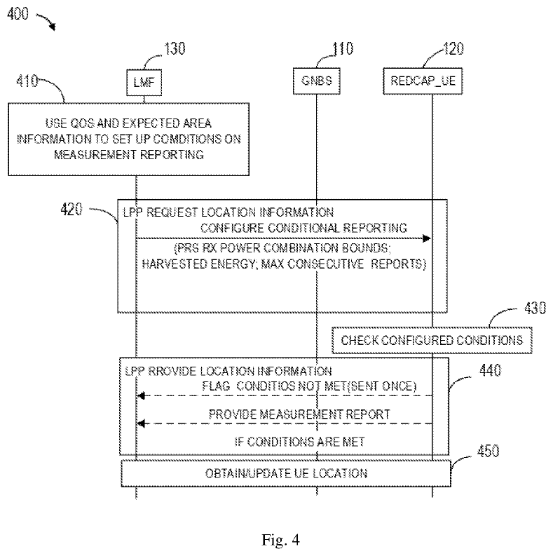

FIG. 4 illustrates an example of an optimized conditional measurement reporting procedure which may be used in example embodiments of the present disclosure. FIG. 4 gives an example of new solution that the network configures the RedCap_UE with a conditional measurement reporting.

As shown in FIG. 4, in step 410, the LMF 130 may use QoS and expected area information to set up conditions on measurement reporting. In step 420, the LMF 130 may configure the conditional reporting to the RedCap_UE 120 by transmitting a LPPRequestLocationInformation message (i.e., first message) to the RedCap_UE 120. The LPPRequestLocationInformation message may carry the conditions set above, and the set conditions which may include PRS Rx power combination bounds, harvested energy configuration and max consecutive reports. In step 430, after receiving conditions from the LMF 130, the RedCap_UE 120 may check whether the configured conditions are met. In step 440, the RedCap_UE 120 may then transmit a LPPProvideLocationInformation message (i.e., second message) to the LMF 130. The LPPProvideLocationInformation message may carry a measurement report when the configured conditions have been met by the RedCap_UE 120. When the configured conditions have not been met by the RedCap_UE 120, the LPPProvideLocationInformation message may not carry a measurement report, and may instead carry a new IE (information element) flagging that the configured conditions are not met by the RedCap_UE 120 or a null input. The new IE flagging that the configured conditions have not been met by the RedCap_UE 120 may be sent only once as a response to the conditions within the LPPRequestLocationInformation message. In step 450, the LMF 130 may obtain an update on the location of the RedCap_UE 120 based on the reporting of the one or more measurements performed by the RedCap_UE 120.

In an embodiment, a network node gNB 132 may facilitate the signaling of sending of the set up conditions for reporting the one or more measurements performed by the RedCap_UE 120, and the signaling of the LPPRequestLocationInformation message and the LPPProvideLocationInformation message to the LMF 130. Yet in another embodiment, the network node gNB 132 may be integrated with the functions of the LMF 130, thus performing the role of the LMF 130 in the network 100.

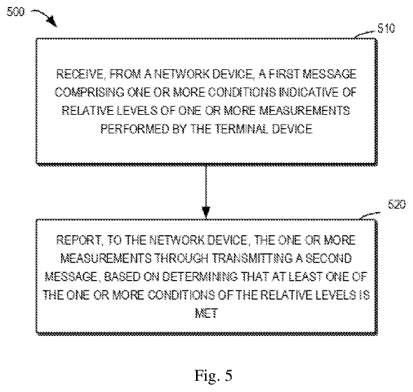

FIG. 5 illustrates a flowchart of a method 500 implemented at a terminal device 120 according to some embodiments of the present disclosure. For the purpose of discussion, the method 500 will be described from the perspective of the terminal device 120 with reference to FIG. 1. It is to be understood that method 500 may further include additional blocks not shown and/or omit some shown blocks, and the scope of the present disclosure is not limited in this regard.

In step 510, the terminal device 120 may receive, from a network device 130, a first message may include one or more conditions indicative of relative levels of one or more measurements performed by the terminal device 120. In step 520, the terminal device 120 may report, to the network device 130, the one or more measurements through transmitting a second message, based on determining that at least one of the one or more conditions of the relative levels is met.

In some embodiments, the one or more measurements performed by the terminal device may include at least one of: positioning reference signal (PRS) combinations from different transmission reception points (TRP (105, 110, 115)) to be measured by the terminal device 120 for reporting; a harvested energy configuration of the terminal device; time duration between reports in case of periodic positioning by the terminal device 120, or a maximum number of consecutive reports in case of periodic positioning by the terminal device 120.

In some embodiments, the first message may include a request to provide positioning-related measurements message, and the second message may include a provision of positioning-related measurements message. In some embodiments, the one or more conditions may be included as at least one information element within the first message.

In some embodiments, the second message may include location measurements or updates of the location measurements for determining a location of the terminal device. In some embodiments, the terminal device 120 may report through the second message to the network device without reporting location measurements, to indicate that none of the conditions of the relative levels has been met by the terminal device. In some embodiments, the second message may include an indication flagging one or more conditions of the relative levels that have not been met by the terminal device 120.

In some embodiments, the flagged one or more conditions of the relative levels that have not been met by the terminal device may be transmitted once, in response to the receiving of the first message from the network device 130.

In some embodiments, the receiving of the first message from the network device 130 may be conditioned upon the network device first defining the one or more conditions of the relative levels of the one or more measurements that are at least to be partially met by the terminal device 120, in order to report or to update the one or more location measurements of the terminal device 120.

In some embodiments, the one or more conditions may be terminal device specific which may be based on specifying at least one of: a quality of service (QoS) for a positioning session of the terminal device 120, or expected area information of the terminal device.

In some embodiments, the reporting of the location measurements of the terminal device through the second message may be aperiodic and may take place when one or more conditions of the relative levels are met by the terminal device 120.

In some embodiments, the reporting of the location measurements or a location updated by the terminal device 120 may enable a new positioning determination or a movement detection of the terminal device 120.

In some embodiments, the PRS combinations to be measured by the terminal device for the reporting may be based on a change of reference signal received power (RSRP) that exceeds a threshold which is specific to location measurements.

In some embodiments, the condition indicative of the relative levels of the measurements of the PRS combinations from the different transmission reception points (TRP) (105, 110, 115) performed by the terminal device 120 may be met by determining at least one or a combination of: the PRS received powers have changed more than a defined power units; measured time differences of arrival have changed more than a defined time durations; or the PRS combinations exceed configured bounds.

In some embodiments, the condition indicative of the relative levels of the measurements of the harvested energy configuration may be met by determining that the harvesting energy is greater than or equal to an energy threshold.

In some embodiments, the condition associated with the time duration between reports may be based on after determining that the condition associated with the PRS combinations is not met in case of periodic positioning of the terminal device, determine a time interval after transmitting a measurement report is equal to the time duration between reports.

In some embodiments, the condition associated with the maximum number of consecutive measurement reports may be based on after determining that the condition associated with the PRS combinations and the harvested energy configuration are met in case of periodic positioning of the terminal device, wherein the terminal device 120 is caused to determine a number of consecutive measurement reports that have been transmitted is less than the maximum number of consecutive measurement reports. In some embodiments, a reporting periodicity may be determined based on a scaling factor associated to a mobility of the terminal device 120.

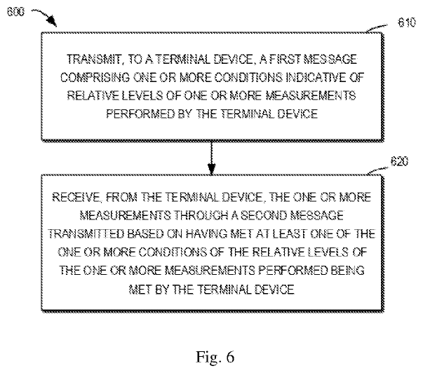

FIG. 6 illustrates a flowchart of a method implemented at a network device 130 according to some embodiments of the present disclosure. For the purpose of discussion, the method 600 will be described from the perspective of the network device 130 with reference to FIG. 1. It is to be understood that method 600 may further include additional blocks or steps not shown and/or omit some shown blocks, and the scope of the present disclosure is not limited in this regard.

At block 610, the network device 130 may transmit, to a terminal device 120, a first message that may include one or more conditions indicative of relative levels of one or more measurements performed by the terminal device. At block 620, the network device 130 may receive, from the terminal device 120, the one or more measurements through a second message transmitted based on having met at least one of the one or more conditions of the relative levels of the one or more measurements performed by the terminal device 120.

In some embodiments, the one or more measurements performed by the terminal device 120 may include at least one of: positioning reference signal (PRS) combinations from different transmission reception points (TRP) (105, 110, 115) to be measured by the terminal device 120 for reporting; a harvested energy configuration of the terminal device; time duration between reports in case of periodic positioning by the terminal device 120, or a maximum number of consecutive reports in case of periodic positioning by the terminal device 120.

In some embodiments, the first message may include a request to provide positioning-related measurements message, and the second message may include a provision of positioning-related measurements message. In some embodiments, the one or more conditions may be included as information elements within the first message.

In some embodiments, the second message may include location measurements or updates of the location measurements for determining a location of the terminal device.

In some embodiments, the second message without reporting location measurements may be received from the terminal device 120, to indicate that none of the conditions of the relative levels has been met by the terminal device 120.

In some embodiments, the second message includes an indication flagging one or more conditions of the relative levels that have not been met by the terminal device 120. In some embodiments, the flagged one or more conditions of the relative levels that have not been met by the terminal device 120 may be received once, in response to the receiving of the first message from the network device 130.

In some embodiments, the one or more conditions may be conditioned upon the network device 130 first defining the one or more conditions of the relative levels that may be at least to be partially met by the terminal device 120, in order to report or to update the one or more location measurements of the terminal device 120.

In some embodiments, the one or more conditions may be terminal device specific which may be based on specifying at least one of: a quality of service (QoS) for a positioning session of the terminal device, or expected area information of the terminal device.

In some embodiments, the reporting of the location measurements of the terminal device 120 through the second message may be aperiodic, which may take place when one or more the conditions of the relative levels are met by the terminal device 120.

In some embodiments, the reporting of the location measurement or a location updated by the terminal device 120 may enable a new positioning determination or a movement detection of the terminal device.

In some embodiments, the PRS combinations to be measured by the terminal device 120 for the reporting is based on a change of reference signal received power (RSRP) that exceeds a threshold which is specific to location measurements.

In some embodiments, the network device 130 may determine the PRS combinations based on an expected area of interest and a topology of transmission reception points (TRP).

In some embodiments, an apparatus capable of performing any of the method 500 (for example, the terminal device 120) may include means for performing the respective steps of the method 500. The means may be implemented in any suitable form. For example, the means may be implemented in a circuitry or software module.

In some embodiments, the apparatus includes: means for receiving, at a terminal device from a network device, a first message may include one or more conditions indicative of relative levels of one or more measurements performed by the terminal device; and means for reporting, to the network device, the one or more measurements through transmitting a second message, based on determining that at least one of the one or more conditions of the relative levels is met.

In some embodiments, the one or more measurements performed by the terminal device include at least one of: positioning reference signal (PRS) combinations from different transmission reception points (TRP) to be measured by the terminal device for reporting; a harvested energy configuration of the terminal device; time duration between reports in case of periodic positioning by the terminal device, or a maximum number of consecutive reports in case of periodic positioning by the terminal device.

In some embodiments, the first message includes a request to provide positioning-related measurements message, or the second message includes a provision of positioning-related measurements message. In some embodiments, the one or more conditions may be included as at least one information element within the first message.

In some embodiments, the second message includes location measurements or updates of the location measurements for determining a location of the terminal device.

In some embodiments, the apparatus includes: means for reporting through the second message to the network device without reporting location measurements, to indicate that none of the conditions of the relative levels has been met by the terminal device.

In some embodiments, the second message includes an indication flagging one or more conditions of the relative levels that have not been met by the terminal device.

In some embodiments, the flagged one or more conditions of the relative levels that have not been met by the terminal device is transmitted once, in response to the receiving of the first message from the network device.

In some embodiments, the receiving of the first message from the network device is conditioned upon the network device first defining the one or more conditions of the relative levels that may at least to be partially met by the terminal device, in order to report or to update the one or more location measurements of the terminal device.

In some embodiments, the one or more conditions may be terminal device specific which are based on specifying at least one of: a quality of service (QoS) for a positioning session of the terminal device, or expected area information of the terminal device.

In some embodiments, the reporting of the location measurements of the terminal device through the second message is aperiodic and takes place when one or more conditions of the relative levels are met by the terminal device.

In some embodiments, the reporting of the location measurements or a location updated by the terminal device enables a new positioning determination or a movement detection of the terminal device.

In some embodiments, the PRS combinations to be measured by the terminal device for the reporting is based on a change of reference signal received power (RSRP) that exceeds a threshold which is specific to location measurements.

In some embodiments, the condition indicative of the relative levels of the measurements of the PRS combinations from the different transmission reception points (TRP) performed by the terminal device is met by determining at least one or a combination of: the PRS received powers have changed more than a defined power units; measured time differences of arrival have changed more than a defined time durations; or the PRS combinations exceed configured bounds.

In some embodiments, the condition indicative of the relative levels of the measurements of the harvested energy configuration is met by: determining that the harvesting energy is greater than or equal to an energy threshold.

In some embodiments, the condition associated with the time duration between reports is based on after determining that the condition associated with the PRS combinations is not met in case of periodic positioning of the terminal device, determine a time interval after transmitting a measurement report is equal to the time duration between reports.

In some embodiments, the condition associated with the maximum number of consecutive measurement reports is based on after determining that the condition associated with the PRS combinations and the harvested energy configuration are met in case of periodic positioning of the terminal device, wherein the terminal device 120 is caused to determine a number of consecutive measurement reports that have been transmitted is less than the maximum number of consecutive measurement reports. In some embodiments, a reporting periodicity is determined based on a scaling factor associated to a mobility of the terminal device.

In some embodiments, the apparatus may further include means for performing other steps in some embodiments of the method 500. In some embodiments, the means includes at least one processor; and at least one memory including computer program code, the at least one memory and computer program code configured to, with the at least one processor, cause the performance of the apparatus.

In some embodiments, an apparatus capable of performing any of the method 600 (for example, the network device 130) may include means for performing the respective steps of the method 600. The means may be implemented in any suitable form. For example, the means may be implemented in a circuitry or software module.

In some embodiments, the apparatus includes: means for transmitting, at a network device to a terminal device, a first message may include one or more conditions indicative of relative levels of one or more measurements performed by the terminal device; and means for receiving, from the terminal device, the one or more measurements through a second message transmitted based on having met at least one of the one or more conditions of the relative levels of the one or more measurements performed by the terminal device.

In some embodiments, the one or more measurements performed by the terminal device may include at least one of: positioning reference signal (PRS) combinations from different transmission reception points (TRP) to be measured by the terminal device for reporting; a harvested energy configuration of the terminal device; time duration between reports in case of periodic positioning by the terminal device, or a maximum number of consecutive reports in case of periodic positioning by the terminal device.

In some embodiments, the first message may include a request to provide positioning-related measurements message, or the second message may include a provision of positioning-related measurements message. In some embodiments, the one or more conditions may be included as at least one information element within the first message.

In some embodiments, the second message may include location measurements or updates of the location measurements for determining a location of the terminal device.

In some embodiments, the second message without reporting location measurements is received from the terminal device, to indicate that none of the conditions of the relative levels has been met by the terminal device. In some embodiments, the second message may include an indication flagging one or more conditions of the relative levels that have not been met by the terminal device. In some embodiments, the flagged one or more conditions of the relative levels that have not been met by the terminal device is received once, in response to the receiving of the first message from the network device.

In some embodiments, the one or more conditions may be conditioned upon the network device 130 first defining the one or more conditions of the relative levels that may at least to be partially met by the terminal device 120, in order to report or to update the one or more location measurements of the terminal device.

In some embodiments, the one or more conditions may be terminal device specific which are based on specifying at least one of: a quality of service (QoS) for a positioning session of the terminal device, or expected area information of the terminal device.

In some embodiments, the reporting of the location measurements of the terminal device through the second message is aperiodic and takes place when one or more conditions of the relative levels are met by the terminal device.

In some embodiments, the reporting of the location measurements or a location updated by the terminal device enables a new positioning determination or a movement detection of the terminal device.

In some embodiments, the PRS combinations to be measured by the terminal device for the reporting is based on a change of reference signal received power (RSRP) that exceeds a threshold which is specific to location measurements.

In some embodiments, the apparatus further includes: means for determining the PRS combinations based on an expected area of interest and a topology of transmission reception points (TRP).

In some embodiments, the apparatus further includes means for performing other steps in some embodiments of the method 600. In some embodiments, the means includes at least one processor; and at least one memory including computer program code, the at least one memory and computer program code configured to, with the at least one processor, cause the performance of the apparatus.

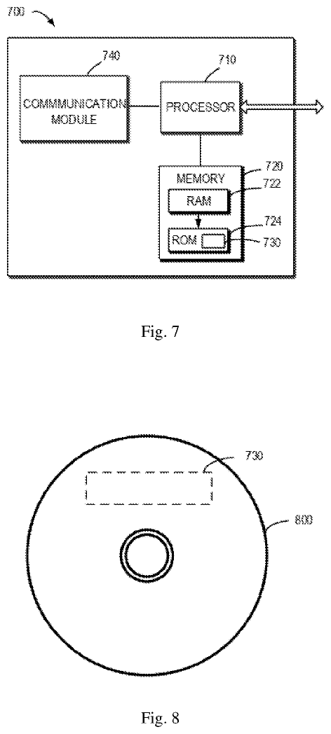

FIG. 7 is a simplified block diagram of a device 700 that is suitable for implementing embodiments of the present disclosure. The device 700 may be provided to implement the communication device, for example the terminal device 120, the network device 130 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out procedure 200 or 400, or the method 500 or 600 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-37. (canceled)

38. A terminal device, comprising:
at least one processor; and
at least one memory storing instructions that, when executed by the at least one processor, cause the terminal device at least to:
receive, from a network device, a first message comprising one or more conditions indicative of relative levels of one or more measurements performed by the terminal device; and
report, to the network device, the one or more measurements through transmitting a second message, based on determining that at least one of the one or more conditions of the relative levels is met.

39. The terminal device of claim 38, wherein the one or more measurements performed by the terminal device comprise at least one of:
positioning reference signal (PRS) combinations from different transmission reception points (TRP) to be measured by the terminal device for reporting;
a harvested energy configuration of the terminal device;
time duration between reports in case of periodic positioning by the terminal device, or a maximum number of consecutive reports in case of periodic positioning by the terminal device.

40. The terminal device of claim 38, wherein at least one of:
the first message comprises a request to provide positioning-related measurements message, or
the second message comprises a provision of positioning-related measurements message.

41. The terminal device of claim 38, wherein the one or more conditions are included as at least one information element within the first message.

42. The terminal device of claim 38, wherein the second message comprises location measurements or updates of the location measurements for determining a location of the terminal device.

43. The terminal device of claim 42, wherein the terminal device is caused to:
report through the second message to the network device without reporting location measurements, to indicate that none of the conditions of the relative levels has been met by the terminal device.

44. The terminal device of claim 43, wherein the second message comprises an indication flagging one or more conditions of the relative levels that have not been met by the terminal device.

45. The terminal device of claim 44, wherein the flagged one or more conditions of the relative levels that have not been met by the terminal device is transmitted once, in response to the receiving of the first message from the network device.

46. The terminal device of claim 42, wherein the receiving of the first message from the network device is conditioned upon the network device first defining the one or more conditions of the relative levels of the one or more measurements that are at least to be partially met by the terminal device, in order to report or to update the one or more location measurements of the terminal device.

47. The terminal device of claim 46, wherein the one or more conditions are terminal device specific which are based on specifying at least one of:
a quality of service (QoS) for a positioning session of the terminal device, or expected area information of the terminal device.

48. The terminal device of claim 42, wherein the reporting of the location measurements of the terminal device through the second message is aperiodic and takes place when one or more conditions of the relative levels are met by the terminal device.

49. The terminal device of claim 48, wherein the reporting of the location measurements or a location updated by the terminal device enables a new positioning determination or a movement detection of the terminal device.

50. The terminal device of claim 39, wherein the PRS combinations to be measured by the terminal device for the reporting is based on a change of reference signal received power (RSRP) that exceeds a threshold which is specific to location measurements.

51. The terminal device of claim 39, wherein the condition indicative of the relative levels of the measurements of the PRS combinations from the different transmission reception points (TRP) performed by the terminal device is met by determining at least one or a combination of:
the PRS received powers have changed more than a defined power units;
measured time differences of arrival have changed more than a defined time duration; or the PRS combinations exceed configured bounds.

52. The terminal device of claim 39, wherein the condition indicative of the relative levels of the measurements of the harvested energy configuration is met by:
determining that the harvesting energy is greater than or equal to an energy threshold.

53. The terminal device of claim 50, wherein the condition associated with the time duration between reports is: based on after determining that the condition associated with the PRS combinations is not met in case of periodic positioning of the terminal device, determine a time interval after transmitting a measurement report is equal to the time duration between reports.

54. The terminal device of claim 50, wherein the condition associated with the maximum number of consecutive measurement reports is based on after determining that the condition associated with the PRS combinations and the harvested energy configuration are met in case of periodic positioning of the terminal device, wherein the terminal device is caused to determine a number of consecutive measurement reports that have been transmitted is less than the maximum number of consecutive measurement reports.

55. The terminal device of claim 54, wherein a reporting periodicity is determined based on a scaling factor associated to a mobility of the terminal device.

56. A network device, comprising:
at least one processor; and
at least one memory storing instructions that, when executed by the at least one processor, cause the network device at least to:
transmit, to a terminal device, a first message comprising one or more conditions indicative of relative levels of one or more measurements performed by the terminal device; and
receive, from the terminal device, the one or more measurements through a second message transmitted based on having met at least one of the one or more conditions of the relative levels of the one or more measurements performed by the terminal device.

57. The network device of claim 56, wherein the one or more measurements performed by the terminal device comprising at least one of:
positioning reference signal (PRS) combinations from different transmission reception points (TRP) to be measured by the terminal device for reporting;
a harvested energy configuration of the terminal device;
time duration between reports in case of periodic positioning by the terminal device, or a maximum number of consecutive reports in case of periodic positioning by the terminal device.
